(19) United States
(12) Patent Application Publication
(10) Pub. No.: US 2024/0087488 A1
(43) Pub. Date: Mar. 14, 2024

(54) DYNAMIC DISPLAY ALIGNMENT WITH LEFT AND RIGHT IMAGE OVERLAY

(71) Applicant: Google LLC, Mountain View, CA (US)

(72) Inventors: Shreyas Potnis, Kitchener (CA); Eliezer Glik, San Diego, CA (US); Daniel Adema, Kitchener (CA)

(21) Appl. No.: 18/462,253

(22) Filed: Sep. 6, 2023

Related U.S. Application Data
(60) Provisional application No. 63/374,771, filed on Sep. 7, 2022.

(51) Int. Cl. G09G 3/00

(52) U.S. Cl. CPC G09G 3/002; G09G 2320/0693; G09G 2340/0471; G09G 2340/12

(57) ABSTRACT

Improved techniques include providing a coupling element on a nose bridge that can overlay left and right images output from respective outcouplers and send the overlay image to a sensor. Based on at least a portion of the overlay image, the sensor may cause the left, right, or both field of views to move until the left and right images are aligned.

### CROSS REFERENCE TO RELATED APPLICATION

This application claims the benefit of U.S. Provisional Application No. 63/374,771, filed on Sep. 7, 2022, the disclosure of which is incorporated herein by reference in its entirety.

### TECHNICAL FIELD

This description relates in general to head mounted wearable devices, and in particular, to head mounted wearable computing devices including a display device.

### SUMMARY

This disclosure relates to mechanisms for eyewear in augmented or mixed reality (AR/MR) that ensure alignment of real and virtual objects on left and right images regardless of the bending of the eyewear frame. Herein is provided a coupling element on a nose bridge that can overlay left and right images output from respective outcouplers and send the overlay image to a sensor. Based on at least a portion of the overlay image, the sensor may cause the left, right, or both field of views to move until the left and right images are aligned—vertically, horizontally, and/or rotationally.

In one general aspect, a head-mounted wearable device includes a frame worn by a user. The frame includes a projection system configured to emit internally generated radiation a left waveguide and a right waveguide. The frame also includes a left waveguide and a right waveguide. The left waveguide includes a left incoupler configured to couple the internally generated radiation and externally generated radiation into the waveguide to produce left radiation in the waveguide, and a left outcoupler configured to couple the left radiation in the left waveguide out of the left waveguide to produce left outcoupled radiation, the left outcoupled radiation representing a left image. The right waveguide includes a right incoupler configured to couple the internally generated radiation and externally generated radiation into the waveguide to produce right radiation in the waveguide, and a right outcoupler configured to couple the right radiation in the right waveguide out of the right waveguide to produce right outcoupled radiation, the right outcoupled radiation representing a right image. The head-mounted wearable device also includes a coupling element coupled to the left outcoupler and the right outcoupler, the coupling element configured to aggregate the left outcoupled radiation and the right outcoupled radiation to produce an overlay image. The head-mounted wearable device further includes a sensor element coupled to the coupling element, the sensor element configured to determine a degree of vertical misalignment of the left image and the right image based on the over lay image.

In another general aspect, a method includes causing internally generated radiation to be emitted into a left waveguide and a right waveguide, the left waveguide includes a left incoupler configured to couple the internally generated radiation and externally generated radiation into the waveguide to produce left radiation in the waveguide, and a left outcoupler configured to couple the left radiation in the left waveguide out of the left waveguide to produce left outcoupled radiation, the left outcoupled radiation representing a left image. The right waveguide includes a right incoupler configured to couple the internally generated radiation and externally generated radiation into the waveguide to produce right radiation in the waveguide, and a right outcoupler configured to couple the right radiation in the right waveguide out of the right waveguide to produce right outcoupled radiation, the right outcoupled radiation representing a right image. The method also includes determining a degree of vertical misalignment of the left image and the right image based on the overlay image formed by a coupling element, the coupling element coupled to the left outcoupler and the right outcoupler, the coupling element configured to aggregate the left outcoupled radiation and the right outcoupled radiation to produce the overlay image.

In another general aspect, a computer program product comprising a nontransitory storage medium, the computer program product including code that, when executed by processing circuitry, causes the processing circuitry to perform a method, the method including causing internally generated radiation to be emitted into a left waveguide and a right waveguide, the left waveguide includes a left incoupler configured to couple the internally generated radiation and externally generated radiation into the waveguide to produce left radiation in the waveguide, and a left outcoupler configured to couple the left radiation in the left waveguide out of the left waveguide to produce left outcoupled radiation, the left outcoupled radiation representing a left image. The right waveguide includes a right incoupler configured to couple the internally generated radiation and externally generated radiation into the waveguide to produce right radiation in the waveguide, and a right outcoupler configured to couple the right radiation in the right waveguide out of the right waveguide to produce right outcoupled radiation, the right outcoupled radiation representing a right image. The method also includes determining a degree of vertical misalignment of the left image and the right image based on the overlay image formed by a coupling element, the coupling element coupled to the left outcoupler and the right outcoupler, the coupling element configured to aggregate the left outcoupled radiation and the right outcoupled radiation to produce the overlay image.

The details of one or more implementations are set forth in the accompanying drawings and the description below. Other features will be apparent from the description and drawings, and from the claims.

### BRIEF DESCRIPTION OF THE DRAWINGS

FIG. 1A illustrates an example system, in accordance with implementations described herein.

FIG. 1B is a front view, FIG. 1C is a rear view, and FIG. 1D is a perspective view, of the example head mounted wearable device shown in FIG. 1A, in accordance with implementations described herein.

FIG. 2 is a top view of smartglasses with misaligned left and right images.

FIG. 3 is a top view of an alignment system for aligning left and right images in smartglasses.

FIG. 4 is a diagram illustrating an example electronic environment for determining vertical misalignment of left and right images in smartglasses.

FIG. 5 is a flow chart illustrating a method of determining vertical misalignment in left and right images.

### DETAILED DESCRIPTION

Eyewear in the form of glasses may be worn by a user to, for example, provide for vision correction, inhibit sun/glare, provide a measure of safety, and the like. These types of eyewear are typically somewhat flexible and/or deformable, so that the eyewear can be manipulated to comfortably fit the user. An ophthalmic technician can typically manipulate rim portions and/or temple arm portions of a frame of the eyewear, for example, through cold working the frame and/or heating and re-working the frame, to adjust the eyewear for a particular user. In some situations, this re-working of the frame may occur over time, through continued use/wearing of the eyewear by the user. Manipulation in this manner, due to the flexible and/or deformable nature of the material of the frame and/or lenses of the eyewear, may provide a comfortable fit while still maintaining ophthalmic alignment between the eyewear and the user. In a situation in which the eyewear is a head mounted computing device including a display, such as, for example, smart glasses, this type of flexibility/deformation in the frame may cause inconsistent alignment or the display, or misalignment of the display. Inconsistent alignment, or misalignment of the display can cause visual discomfort, particularly in the case of a binocular display. A frame having rigid/non-flexible components, while still providing some level of flexibility in certain portions of the frame, may maintain alignment of the display, and may be effective in housing electronic components of such a head mounted computing device including a display.

This disclosure relates to mechanisms for eyewear in augmented or mixed reality (AR/MR) that ensure alignment of real and virtual objects on left and right images regardless of the bending of the eyewear frame. For example, ophthalmic glasses frames should have some compliance or flexibility for the comfort of the wearer. Such glasses are typically somewhat flexible and/or deformable so that the glasses can be manipulated to adapt to a particular head size and/or shape, a particular arrangement of features, a preferred pose of the glasses on the face, and the like, associated with a user to provide a comfortable fit for the user. Along these lines, a frame of the eyewear can be deformed by, for example, heating and re-forming plastic frames, or bending/flexing frames made of other materials. Thus, flexible or deformable characteristics of the material of the frame of the eyewear may allow the eyewear to be customized to fit a particular user, while still maintaining the functionality of the eyewear.

A technical problem with allowing such flexibility in the frame is that such flexibility may cause misalignment of left and right images. Such misalignment may result in discomfort for the user.

A conventional solution to the above-described technical problem involves keeping the frame of the eyewear rigid to avoid any flexibility that could cause the displays to move and vertically misalign the left and right images in the displays. This solution, however, may add undesirable weight to the eyewear and cause the user to experience discomfort wearing the eyewear.

Another conventional solution to the above-described technical problem involves providing secondary outcouplers configured to output to a pair of cameras on, e.g., a rigid nose bridge. A controller may then compare the images from either camera and determine a degree of misalignment. Nevertheless, such a solution requires imaging of an entire field of view, analysis of which may be too time consuming and/or resource intensive to be practical in real time.

In contrast to the above-described conventional solutions, an improved technical solution to the technical problem includes providing a coupling element on a nose bridge that can overlay left and right images output from respective outcouplers and send the overlay image to a sensor. Based on at least a portion of the overlay image, the sensor may cause the left, right, or both field of views to move until the left and right images are aligned. For example, upon comparison of the overlay image with an initial overlay image produced at a factory calibration in which left and right images are in alignment.

A technical advantage of the above-described technical solution is that full field-of-views are not needed to make the overlay image. Rather, simple test patterns—or portions thereof—may be used instead during a calibration step or even in real time during use.

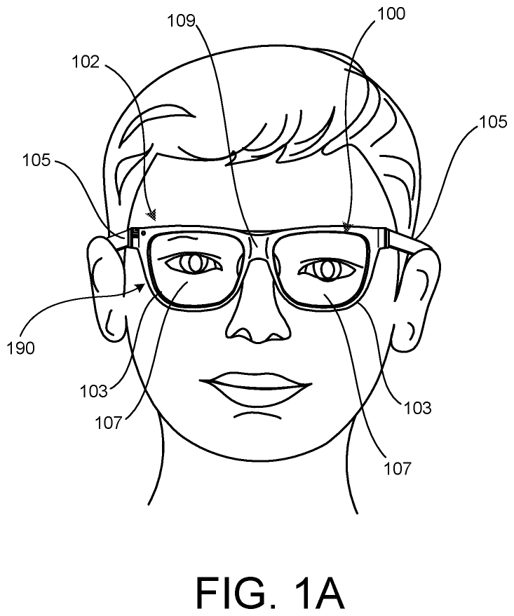

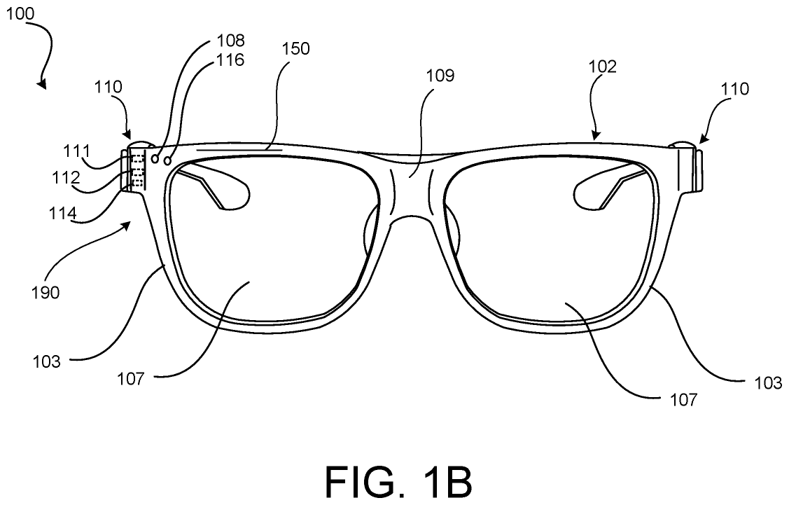

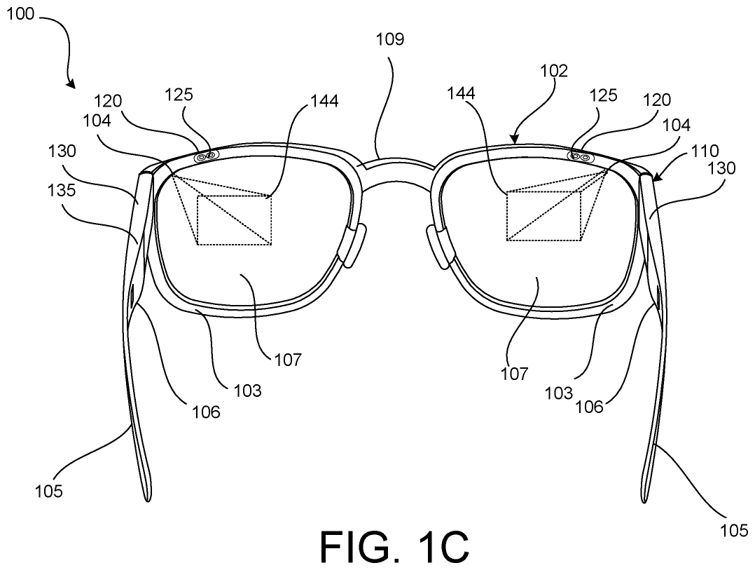

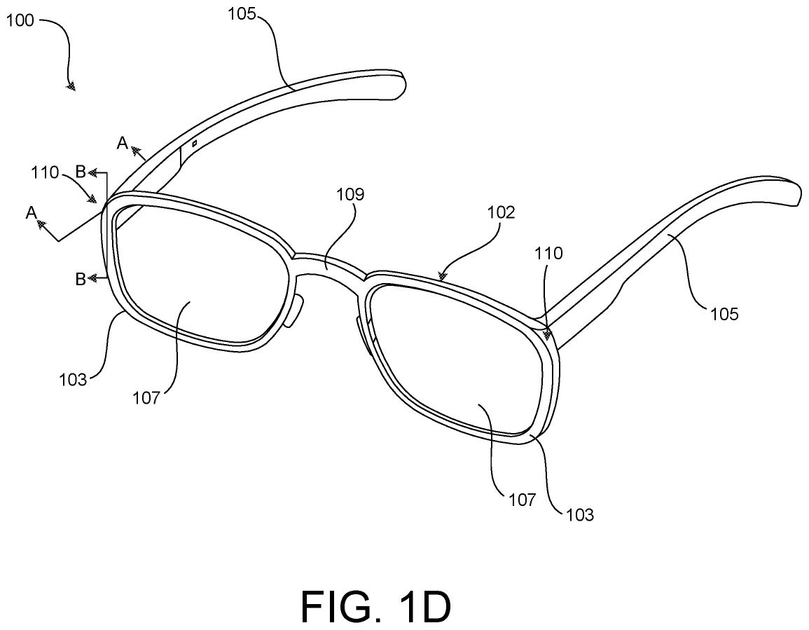

FIG. 1A illustrates a user wearing an example head-mounted wearable device 100. In this example, the example head mounted wearable device 100 is in the form of example smart glasses including display capability and computing/processing capability, for purposes of discussion and illustration. The principles to be described herein may be applied to other types of eyewear, both with and without display capability and/or computing/processing capability. FIG. 1B is a front view, FIG. 1C is a rear view, and FIG. 1D is a perspective view, of the example head mounted wearable device 100 shown in FIG. 1A. As noted above, in some examples, the example head mounted wearable device 100 may take the form of a pair of smart glasses, or augmented reality glasses.

As shown in FIG. 1B-1D, the example head-mounted wearable device 100 includes a frame 102. The frame 102 includes a front frame portion defined by rim portions 103 surrounding respective optical portions in the form of lenses 107, with a bridge portion 109 connecting the rim portions 109. Arm portions 105 are coupled, for example, pivotably or rotatably coupled, to the front frame by hinge portions 110 at the respective rim portion 103. In some examples, the lenses 107 may be corrective/prescription lenses. In some examples, the lenses 107 may be an optical material including glass and/or plastic portions that do not necessarily incorporate corrective/prescription parameters. A display device 104 may be coupled in a portion of the frame 102. In the example shown in FIGS. 1B and 1C, the display device 104 is coupled in the arm portion 105 of the frame 102. In some examples, the head mounted wearable device 100 can also include an audio output device 106 (such as, for example, one or more speakers), an illumination device 108, a sensing system 111, a control system 112, at least one processor 114, and an outward facing image sensor 116, or camera 116. In some examples, the display device 104 may include a see-through near-eye display. For example, the display device 104 may be configured to project light from a display source onto a portion of teleprompter glass functioning as a beamsplitter seated at an angle (e.g., 30-45 degrees). The beamsplitter may allow for reflection and transmission values that allow the light from the display source to be partially reflected while the remaining light is transmitted through. Such an optic design may allow a user to see both physical items in the world, for example, through the lenses 107, next to content (for example, digital images, user interface elements, virtual content, and the like) generated by the display device 104. In some implementations, waveguide optics may be used to depict content on the display device 104 via outcoupled light 120.

Waveguide optics 150 within the frame 102 are used to depict content on the display device 104. Such waveguide optics may be sensitive to the frame deformations resulting in real and virtual images that may become misaligned. Given the sensitivity of the waveguide optics 150 to frame deformations, a novel way to align real and virtual images in the display 104 is to reroute incident light from the projector onto an incoupler of the waveguide 150 such that the output light direction (e.g., light output by the waveguide outcoupler) is essentially parallel (e.g., to within 0.5 degrees or less) to the incident (input) light direction. Such a way involves the use of an input light direction retroreflector configured to adjust an initial angle of incidence of the internally generated radiation at a surface of the waveguide 150 to produce radiation directed at an adjusted angle of incidence at an incoupler such that the output direction is essentially parallel to the initial angle of incidence.

In some implementations, left and right images produced by the waveguide 150 may not be aligned. In this case, the at least one processor 114 may be used to detect misalignment of the images and make corrections.

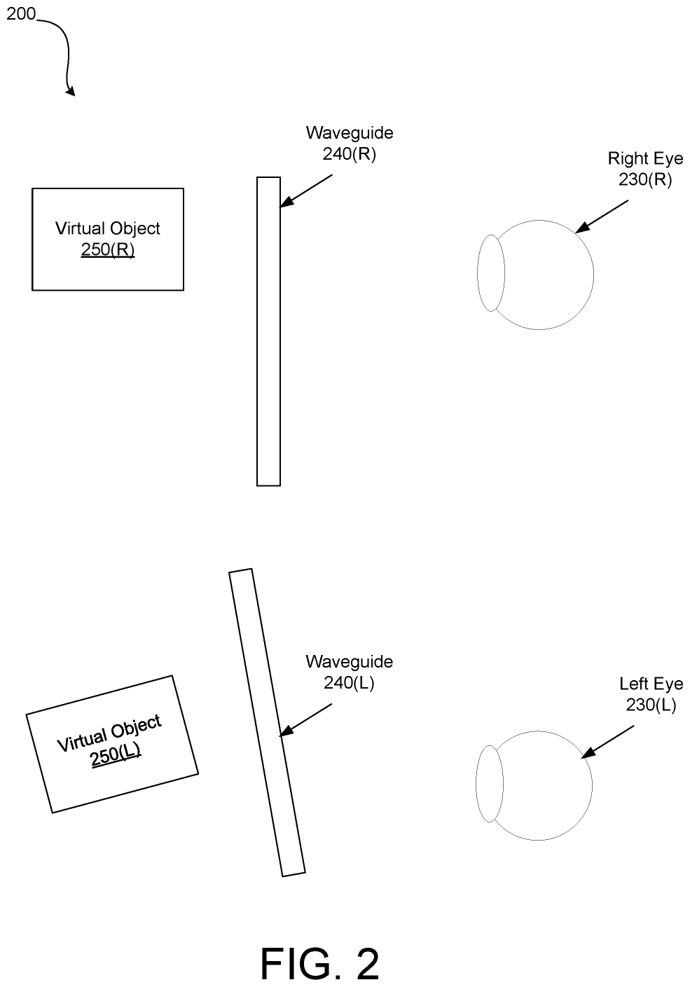

FIG. 2 is a top view 200 of smartglasses with misaligned left and right images. As shown in FIG. 2, a left eye 230(L) images a virtual object 250(L) via a left lens of a smartglasses system. The left lens is in a rim portion of the frame. Above the left lens in the rim portion is a left waveguide 240(L) which takes in light from a projection system in the frame of the smartglasses as well as world-side radiation and directs the combined radiation toward the left eye 230(L).

Also as shown in FIG. 2, a right eye 230(R) images the virtual object 250(R) via a right lens of a smartglasses system. The right lens is in a rim portion of the frame. Above the right lens in the rim portion is a right waveguide 240(R) which takes in light from a projection system in the frame of the smartglasses as well as world-side radiation and directs the combined radiation toward the right eye 230(R).

As illustrated in FIG. 2, the left and right images of the virtual object are misaligned because the frame has been allowed some flex for the comfort of the user, thus causing the directions of the light from the left image and the right image, i.e., from the left and right outcouplers, to reach the respective eyes at different angles. If left uncorrected, such misalignment can cause some discomfort for the user due to lack of vergence.

Correction of the vertical misalignment involves comparing the left image and right image in an overlay image. This is accomplished using a coupler along with processing circuitry used to evaluate an overlay image resulting from combining the left and right images.

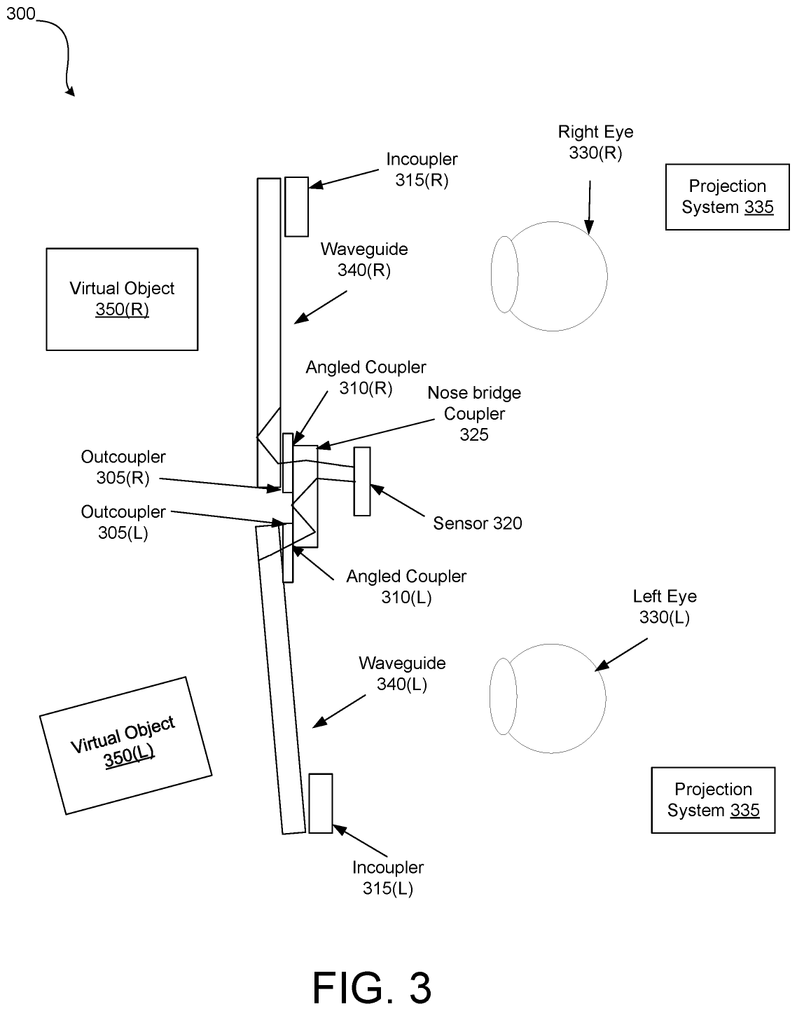

FIG. 3 is a top view of an alignment system 300 for aligning left and right images in smartglasses. As shown in FIG. 3, a left eye 330(L) images a virtual object 350(L) via a left lens of a smartglasses system. The left lens is in a rim portion of the frame. Above the left lens in the rim portion is a left waveguide 340(L) which takes in light from a projection system in the frame of the smartglasses via an incoupler 315(L) as well as world-side radiation and directs the combined radiation, which represents a current left image, toward the left eye 330(L).

Also as shown in FIG. 3, a right eye 330(R) images the virtual object 350(R) via a right lens of a smartglasses system. The right lens is in a rim portion of the frame. Above the right lens in the rim portion is a right waveguide 340(R) which takes in light from a projection system in the frame of the smartglasses via an incoupler 315(R) as well as world-side radiation and directs the combined radiation, which represents a current right image, toward the right eye 330(R).

As shown in FIG. 3, the outcouplers 305(L,R) of the left and right waveguides are coupled to a coupling element 325, or nose bridge coupler if the coupling element 325 is located in an interior of the node bridge of the smartglasses. The coupling element 325 is then coupled to a sensor 320 configured to detect misalignment—vertical, horizontal, or rotational.

To detect misalignment, the system 300 combines the current left image and the current right image to produce a current overlay image. In some implementations, the system 300 also receives an initial overlay image that is comprised of an initial left image and an initial right image, the initial left image and the initial right image being in alignment. In such an implementation, the system 300 performs a comparison between the current overlay image and the initial overlay image to determine the misalignment between the current left image and the current right image.

In some implementations, the coupling element 325 includes a polarization beam splitter, on which a quarter-wave plate and mirror are disposed. In such an implementation, s-polarization-illuminated test pattern from the left outcoupler 305(L) may be overlaid with a p-polarization-illumination test pattern from the right outcoupler 305(R) to produce the current overlay image. Moreover, the initial overlay image would result from a combination of an s-polarized initial left image and a p-polarized initial right image. Again, a degree of misalignment may be deduced from a comparison of the current overlay image and the initial overlay image.

In some implementations, the coupling element 325 in the interior of the nose bridge is coupled to the outcouplers 305(L,R) using angled couplers 310(L,R) that are configured to couple light into the coupling element from the waveguide 340(L) at a range of angles due to the flex in the frame.

The sensor 320 is configured to measure left and right point spread functions (PSFs) resulting from illumination from the projection system, in which case the illumination pattern is a pointwise impulse, e.g., approximating a point source. The sensor 320 then compares left and right PSFs and determines how to offset fields of view (FOVs) (e.g., left, right, or both) to achieve alignment. This determination and the offsetting of the FOVs occurs in real time to account for continuous flexing of the frame.

The FOV offsetting is performed by identifying a number of pixels in the left or right image to shift based on the overlaid PSFs. That is, if the left and right PSFs are misaligned by a number of pixels, then the sensor is configured to offset the FOVs by that number of pixels.

In some implementations, the sensor 320 includes a proportional-integral-derivative (PID) loop. The PID loop is configured to perform the FOV offsetting automatically in response to detecting a difference in the left and right PSFs. Because the PSF difference is expressible in a number of pixels, the PID loop can offset the FOVs by that number of pixels to achieve alignment.

In some implementations, the misalignment of the left and right images are too large for any real-time compensation. In such a situation, there may be significant discomfort on part of the user when the left and right images are severely misaligned. To mitigate such discomfort, the system 300 may perform a power off operation to temporarily shut off power to the system 300. That is, the system 300 may perform a power off when the degree of misalignment of the current left and right images is greater than a threshold, e.g., 5%, 10%, 20%, 50%, or larger.

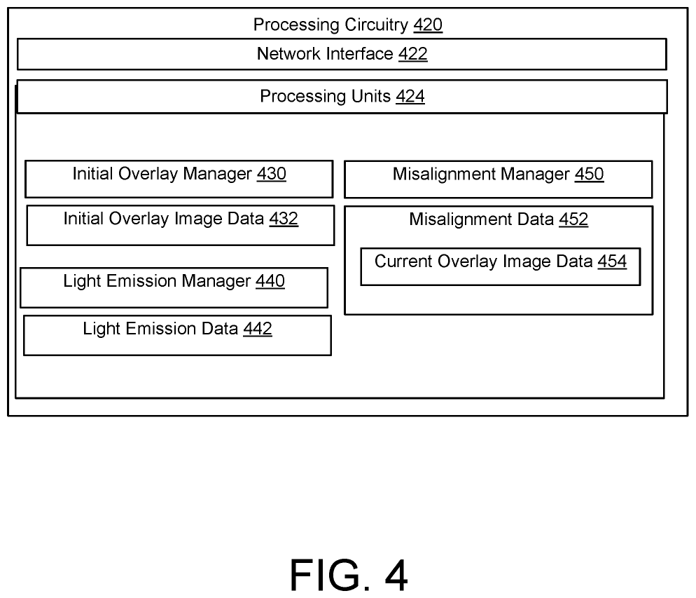

FIG. 4 is a diagram illustrating an example electronic environment for determining an angular deviation between a waveguide and a display of a smartglasses system, which includes processing circuitry 420. The processing circuitry 420 includes a network interface 422, one or more processing units 424, and nontransitory memory (storage medium) 426.

In some implementations, one or more of the components of the processing circuitry 420 can be, or can include processors (e.g., processing units 424) configured to process instructions stored in the memory 426 as a computer program product. Examples of such instructions as depicted in FIG. 4 include initial overlay manager 430, light emission manager 440, and misalignment manager 450. Further, as illustrated in FIG. 4, the memory 426 is configured to store various data, which is described with respect to the respective services and managers that use such data.

The initial overlay manager 430 is configured to receive an initial overlay image as initial overlay image data 432, the initial overlay image being a combination of an initial left image and an initial right image at an initial calibration.

The light emission manager 440 is configured to cause internally generated radiation to be emitted into a left waveguide and a right waveguide. The left waveguide includes a left outcoupler configured to couple left radiation in the left waveguide out of the left waveguide to produce left outcoupled radiation such that the left outcoupled radiation represents a current left image. A right waveguide includes right outcoupler configured to couple right radiation in the right waveguide out of the right waveguide to produce right outcoupled radiation such that the right outcoupled radiation represents a current right image. The light emission data 442 represents the current left image and the current right image.

The misalignment manager 450 is configured to determine a degree of misalignment (misalignment data 452) of the current left image and the current right image based on a current overlay image (current overlay image data 454) formed by a coupling element. The coupling element is coupled to the left outcoupler and the right outcoupler and is configured to combine the current left image and the current right image represented by light emission data 442 to produce the current overlay image. The misalignment manager 450 is further configured to determine a degree of misalignment based on a difference between the current overlay image and the initial overlay image. In some implementations, the misalignment manager 450 performs a power off operation on the processing circuitry 420 in response to the degree of misalignment being greater than a threshold.

The components (e.g., modules, processing units 424) of processing circuitry 420 can be configured to operate based on one or more platforms (e.g., one or more similar or different platforms) that can include one or more types of hardware, software, firmware, operating systems, runtime libraries, and/or so forth. In some implementations, the components of the processing circuitry 420 can be configured to operate within a cluster of devices (e.g., a server farm). In such an implementation, the functionality and processing of the components of the processing circuitry 420 can be distributed to several devices of the cluster of devices.

The components of the processing circuitry 420 can be, or can include, any type of hardware and/or software configured to process private data from a wearable device in a split-compute architecture. In some implementations, one or more portions of the components shown in the components of the processing circuitry 420 in FIG. 4 can be, or can include, a hardware-based module (e.g., a digital signal processor (DSP), a field programmable gate array (FPGA), a memory), a firmware module, and/or a software-based module (e.g., a module of computer code, a set of computer-readable instructions that can be executed at a computer). For example, in some implementations, one or more portions of the components of the processing circuitry 420 can be, or can include, a software module configured for execution by at least one processor (not shown) to cause the processor to perform a method as disclosed herein. In some implementations, the functionality of the components can be included in different modules and/or different components than those shown in FIG. 4, including combining functionality illustrated as two components into a single component.

The network interface 422 includes, for example, wireless adaptors, and the like, for converting electronic and/or optical signals received from the network to electronic form for use by the processing circuitry 420. The set of processing units 424 include one or more processing chips and/or assemblies. The memory 426 includes both volatile memory (e.g., RAM) and non-volatile memory, such as one or more ROMs, disk drives, solid state drives, and the like. The set of processing units 424 and the memory 426 together form processing circuitry, which is configured and arranged to carry out various methods and functions as described herein.

Although not shown, in some implementations, the components of the processing circuitry 420 (or portions thereof) can be configured to operate within, for example, a data center (e.g., a cloud computing environment), a computer system, one or more server/host devices, and/or so forth. In some implementations, the components of the processing circuitry 320 (or portions thereof) can be configured to operate within a network. Thus, the components of the processing circuitry 420 (or portions thereof) can be configured to function within various types of network environments that can include one or more devices and/or one or more server devices. For example, the network can be, or can include, a local area network (LAN), a wide area network (WAN), and/or so forth. The network can be, or can include, a wireless network and/or wireless network implemented using, for example, gateway devices, bridges, switches, and/or so forth. The network can include one or more segments and/or can have portions based on various protocols such as Internet Protocol (IP) and/or a proprietary protocol. The network can include at least a portion of the Internet.

In some implementations, one or more of the components of the processing circuitry 420 can be, or can include, processors configured to process instructions stored in a memory. For example, initial overlay manager 430 (and/or a portion thereof), light detection manager 440 (and/or a portion thereof), and misalignment manager 450 (and/or a portion thereof) are examples of such instructions.

In some implementations, the memory 426 can be any type of memory such as a random-access memory, a disk drive memory, flash memory, and/or so forth. In some implementations, the memory 426 can be implemented as more than one memory component (e.g., more than one RAM component or disk drive memory) associated with the components of the processing circuitry 420. In some implementations, the memory 426 can be a database memory. In some implementations, the memory 426 can be, or can include, a non-local memory. For example, the memory 426 can be, or can include, a memory shared by multiple devices (not shown). In some implementations, the memory 426 can be associated with a server device (not shown) within a network and configured to serve the components of the processing circuitry 420. As illustrated in FIG. 4, the memory 426 is configured to store various data, including initial overlay image data 432, light emission data 442 and misalignment data 452.

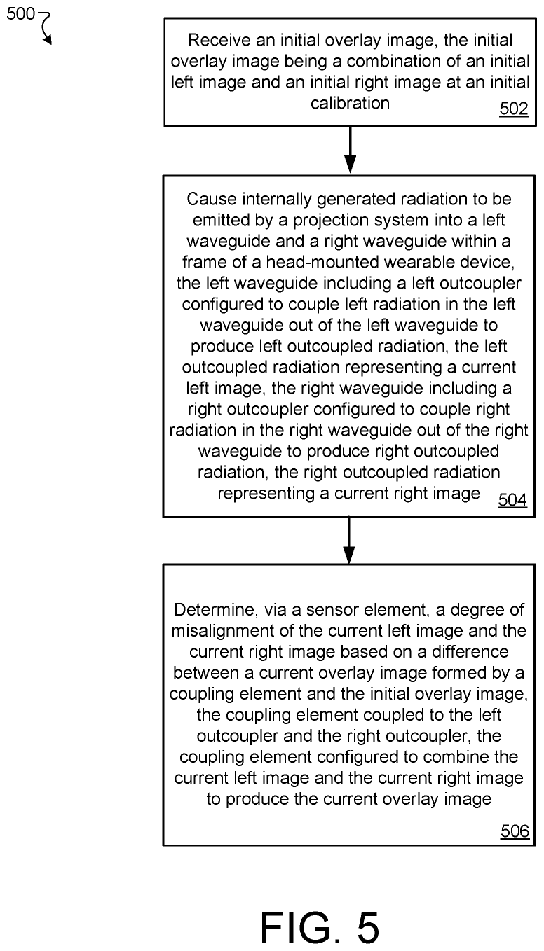

FIG. 5 is a flow chart 500 illustrating a method of determining misalignment in left and right images.

At 502, the initial overlay manager 502 receives an initial overlay image as initial overlay image data 432, the initial overlay image being a combination of an initial left image and an initial right image at an initial calibration.

At 504, the light emission manager 540 causes internally generated radiation to be emitted into a left waveguide and a right waveguide, the left waveguide, including a left incoupler configured to couple the internally generated radiation and externally generated radiation into the left waveguide to produce left radiation in the left waveguide; a left outcoupler configured to couple the left radiation in the left waveguide out of the left waveguide to produce left outcoupled radiation, the left outcoupled radiation representing a current left image; the right waveguide, including a right incoupler configured to couple the internally generated radiation and externally generated radiation into the right waveguide to produce right radiation in the right waveguide; a right outcoupler configured to couple the right radiation in the right waveguide out of the right waveguide to produce right outcoupled radiation, the right outcoupled radiation representing a current right image.

At 506. the misalignment manager 450 determines a degree of misalignment of the current left image and the current right image based on a difference between a current overlay image formed by a coupling element and the initial overlay image, the coupling element coupled to the left outcoupler and the right outcoupler, the coupling element configured to combine the current left image and the current right image to produce the current overlay image.

Specific structural and functional details disclosed herein are merely representative for purposes of describing example embodiments. Example embodiments, however, may be embodied in many alternate forms and should not be construed as limited to only the embodiments set forth herein.

The terminology used herein is for the purpose of describing particular embodiments only and is not intended to be limiting of the embodiments. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of the stated features, steps, operations, elements, and/or components, but do not preclude the presence or addition of one or more other features, steps, operations, elements, components, and/or groups thereof.

It will be understood that when an element is referred to as being “coupled,” “connected,” or “responsive” to, or “on,” another element, it can be directly coupled, connected, or responsive to, or on, the other element, or intervening elements may also be present. In contrast, when an element is referred to as being “directly coupled,” “directly connected,” or “directly responsive” to, or “directly on,” another element, there are no intervening elements present. As used herein the term “and/or” includes any and all combinations of one or more of the associated listed items.

Spatially relative terms, such as “beneath,” “below,” “lower,” “above,” “upper,” and the like, may be used herein for ease of description to describe one element or feature in relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 70 degrees or at other orientations) and the spatially relative descriptors used herein may be interpreted accordingly.

Example embodiments of the concepts are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments of the described concepts should not be construed as limited to the particular shapes of regions illustrated herein but are to include deviations in shapes that result, for example, from manufacturing. Accordingly, the regions illustrated in the figures are schematic in nature and their shapes are not intended to illustrate the actual shape of a region of a device and are not intended to limit the scope of example embodiments.

It will be understood that although the terms “first,” “second,” etc. may be used herein to describe various elements, these elements should not be limited by these terms. These terms are only used to distinguish one element from another. Thus, a “first” element could be termed a “second” element without departing from the teachings of the present embodiments.

Unless otherwise defined, the terms (including technical and scientific terms) used herein have the same meaning as commonly understood by one of ordinary skill in the art to which these concepts belong. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

While certain features of the described implementations have been illustrated as described herein, many modifications, substitutions, changes, and equivalents will now occur to those skilled in the art. It is, therefore, to be understood that the appended claims are intended to cover such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components, and/or features of the different implementations described.

What is claimed is:

1. A head-mounted wearable device, including:
a frame worn by a user, including:
a projection system configured to emit internally generated radiation to a left waveguide and a right waveguide;
the left waveguide, including:
a left incoupler configured to couple the internally generated radiation and externally generated radiation into the left waveguide to produce left radiation in the left waveguide;
a left outcoupler configured to couple the left radiation in the left waveguide out of the left waveguide to produce left outcoupled radiation, the left outcoupled radiation representing a current left image;
the right waveguide, including:
a right incoupler configured to couple the internally generated radiation and externally generated radiation into the right waveguide to produce right radiation in the right waveguide;
a right outcoupler configured to couple the right radiation in the right waveguide out of the right waveguide to produce right outcoupled radiation, the right outcoupled radiation representing a current right image;
a coupling element coupled to the left outcoupler and the right outcoupler, the coupling element configured to combine the left outcoupled radiation and the right outcoupled radiation to produce a current overlay image;
a sensor element coupled to the coupling element, the sensor element configured to determine a degree of misalignment of the current left image and the current right image based on a difference between the current overlay image and an initial overlay image, the initial overlay image being a combination of an initial left image and an initial right image at an initial calibration.

2. The head-mounted wearable device as in claim 1, wherein the frame further includes a nose bridge, and the sensor element is located in an interior of the nose bridge.

3. The head-mounted wearable device as in claim 1, wherein the current left image is a left point spread function resulting from a left pointwise impulse and the current right image is a right point spread function resulting from a right pointwise impulse; and
wherein the degree of misalignment of the current left image and the current right image is based on a difference between the left point spread function and the right point spread function.

4. The head-mounted wearable device as in claim 1, wherein the projection system is further configured to perform an offset of a field of view of the current left image and/or the current right image to produce an aligned image.

5. The head-mounted wearable device as in claim 4, wherein the offset of the field of view is performed by a proportional-integral-derivative (PID) loop of the sensor element.

6. The head-mounted wearable device as in claim 1, further comprising an angled coupler coupled to the left outcoupler, the angled coupler being configured to couple the left outcoupled radiation into the coupling element from the left waveguide at a range of angles.

7. The head-mounted wearable device as in claim 1, wherein the head-mounted wearable device is configured to power off in response to the degree of misalignment being greater than a threshold.

8. A method, comprising:
receiving an initial overlay image, the initial overlay image being a combination of an initial left image and an initial right image at an initial calibration;
causing internally generated radiation to be emitted by a projection system into a left waveguide and a right waveguide within a frame of a head-mounted wearable device, the left waveguide including a left outcoupler configured to couple left radiation in the left waveguide out of the left waveguide to produce left outcoupled radiation, the left outcoupled radiation representing a current left image, the right waveguide including a right outcoupler configured to couple right radiation in the right waveguide out of the right waveguide to produce right outcoupled radiation, the right outcoupled radiation representing a current right image; and
determining, via a sensor element, a degree of misalignment of the current left image and the current right image based on a difference between a current overlay image formed by a coupling element and the initial overlay image, the coupling element coupled to the left outcoupler and the right outcoupler, the coupling element configured to combine the current left image and the current right image to produce the current overlay image.

9. The method as in claim 8, wherein the frame further includes a nose bridge, and the sensor element is located in an interior of the nose bridge.

10. The method as in claim 8, wherein the current left image is a left point spread function resulting from a left pointwise impulse and the current right image is a right point spread function resulting from a right pointwise impulse; and
wherein the degree of vertical misalignment of the current left image and the current right image is based on a difference between the left point spread function and the right point spread function.

11. The method as in claim 8, further comprising performing an offset of a field of view of the current left image and/or the current right image to produce an aligned image.

12. The method as in claim 11, wherein the offset of the field of view is performed by a proportional-integral-derivative (PID) loop.

13. The method as in claim 8, further comprising coupling the left outcoupled radiation into the coupling element from the left waveguide at a range of angles.

14. The method as in claim 8, further comprising:
performing a power off operation in response to the degree of misalignment being greater than a threshold.

15. A computer program product comprising a nontransitory storage medium, the computer program product including code that, when executed by processing circuitry, causes the processing circuitry to perform a method, the method comprising:
receiving an initial overlay image, the initial overlay image being a combination of an initial left image and an initial right image at an initial calibration;
causing internally generated radiation to be emitted by a projection system into a left waveguide and a right waveguide within a frame of a head-mounted wearable device, the left waveguide including a left outcoupler configured to couple left radiation in the left waveguide out of the left waveguide to produce left outcoupled radiation, the left outcoupled radiation representing a current left image, the right waveguide including a right outcoupler configured to couple right radiation in the right waveguide out of the right waveguide to produce right outcoupled radiation, the right outcoupled radiation representing a current right image; and
determining, via a sensor element, a degree of misalignment of the current left image and the current right image based on a difference between a current overlay image formed by a coupling element and the initial overlay image, the coupling element coupled to the left outcoupler and the right outcoupler, the coupling element configured to combine the current left image and the current right image to produce the current overlay image.

16. The computer program product as in claim 15, wherein the frame further includes a nose bridge, and the sensor element is located in an interior of the nose bridge.

17. The computer program product as in claim 15, wherein the current left image is a left point spread function resulting from a left pointwise impulse and the current right image is a right point spread function resulting from a right pointwise impulse; and
wherein the degree of vertical misalignment of the current left image and the current right image is based on a difference between the left point spread function and the right point spread function.

18. The computer program product as in claim 15, wherein the method further comprises performing an offset of a field of view of the current left image and/or the current right image to produce an aligned image.

19. The computer program product as in claim 18, wherein the offset of the field of view is performed by a proportional-integral-derivative (PID) loop.

20. The computer program product as in claim 15, wherein the method further comprises coupling the left outcoupled radiation into the coupling element from the left waveguide at a range of angles.

21. The computer program product as in claim 15, wherein the method further comprises:
performing a power off operation in response to the degree of misalignment being greater than a threshold.
